(19) United States
(12) Patent Application Publication
(10) Pub. No.: US 2023/0360423 A1
(43) Pub. Date: Nov. 9, 2023

(54) UNDERWATER CAMERA BIOMASS DISTRIBUTION FORECAST

(71) Applicant: X Development LLC, Mountain View, CA (US)

(72) Inventors: Julia Black Ling, Redwood City, CA (US); Laura Valentine Chrobak, Menlo Park, CA (US)

(21) Appl. No.: 17/736,205

(22) Filed: May 4, 2022

(51) Int. Cl. G06V 40/10; G06V 10/46; G06V 10/75; G06N 3/08

(52) U.S. Cl. CPC G06V 40/103; G06V 10/46; G06V 10/751; G06N 3/08

(57) ABSTRACT

Methods, systems, and apparatus, including computer programs encoded on computer-storage media, for underwater camera biomass prediction. In some implementations, an exemplary method includes obtaining one or more images of a population of fish captured by an underwater camera; providing data corresponding to the one or more images to a model trained to predict biomass values; obtaining output of the trained model including a predicted biomass value indicating a future biomass of a fish within the population of fish; and determining an action based on the predicted biomass value.

### FIELD

This specification generally relates to camera controllers, particularly those that are used for underwater cameras.

### BACKGROUND

A population of farmed fish may include fish of varying sizes, shapes, and health conditions. In the aquaculture context, prior to harvesting, a worker may remove some fish from the fish pen and weigh them. The manual process of removing the fish from the fish pen and weighing them is both time intensive and potentially harmful to the fish. In addition, because only a small portion of a fish population may be effectively measured in this way, the true characteristics of the population remain unknown.

### SUMMARY

In general, innovative aspects of the subject matter described in this specification relate to obtaining images using an underwater camera and using the images to determine a current biomass distribution of fish populations and projected biomass distribution of fish populations. Individual fish of a current population can be photographed using one or more underwater cameras. Images obtained from cameras can be processed using computer vision and machine learning-based techniques to identify fish within the images and to determine a projected growth or other features of the population over time.

In some implementations, a control unit obtains historic data and generates a projection based on the historic data compared to data obtained from the current population. Data obtained from the current population can include images of fish or data generated from the images of fish such as truss networks. One or more trained models can be used to detect fish within the images and determine one or more features, such as truss lengths, predicted biomass, health features, among others. Models can include neural networks, Random Forest Regressors, Support Vector Regressors, or Gaussian Process Regressors, among others. Projections, also referred to as forecasts, can include projected biomass changes for a population over time. A projected biomass distribution can be generated based on current conditions of a pen, including a current biomass distribution, and historical pen data including historical conditions of one or more pen.

In some implementations, a projected biomass distribution is used to control the amount of feed given to a fish population. For example, after generating a prediction of a projected biomass distribution of a fish population, a control unit can send a signal to a feed distribution system configured to control the feed distribution system to adjust feed provided to the fish population. In some implementations, a projected biomass distribution is used to perform other actions based on decisions computed by a control unit. For example, a control unit can determine a projected biomass distribution of a fish population. Based on the projected biomass distribution of the fish population, the control unit can perform an action. Actions can include generating and sending a signal to a sorting actuator to sort one or more fish from the fish population. Actions can include providing a notification or other data to a user or user device. Actions can include generating and sending a signal to an actuator to perform one or more automated functions related to the fish population.

One innovative aspect of the subject matter described in this specification is embodied in a method that includes obtaining one or more images of a population of fish captured by an underwater camera; providing data corresponding to the one or more images to a model trained to predict biomass values; obtaining output of the trained model including a predicted biomass value indicating a future biomass of a fish within the population of fish; and determining an action based on the predicted biomass value.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The foregoing and other embodiments can each optionally include one or more of the following features, alone or in combination. For instance, in some implementations, the data corresponding to the one or more images includes historical data of the fish, including one or more values indicating historical biomasses of the fish.

In some implementations, actions include training the model, where training the model includes providing a portion of historical data of one or more fish not included in the population of fish to the model; obtaining output of the model indicating predicted biomass values of the one or more fish; generating an error term by comparing the predicted biomass values to known biomass values of the one or more fish included in a second portion of the historical data; and adjusting one or more parameters of the model based on the error term.

In some implementations, adjusting the one or more parameters of the model based on the error term includes providing the error term to the model configured to perform backpropagation.

In some implementations, actions include determining, based on the one or more images, a data set including a value that indicates a length between a first point on the fish and a second point on the fish.

In some implementations, actions include providing the data set including the value that indicates the length between the first point on the fish and the second point on the fish to a model trained to predict biomass; and obtaining output of the model trained to predict biomass as a biomass value of the fish.

In some implementations, the data corresponding to the one or more images includes the biomass value of the fish.

In some implementations, actions include detecting the first point and second point on the fish.

In some implementations, detecting the points includes providing the images to a model trained to detect feature points on a fish body.

In some implementations, actions include detecting the fish within the image using a model trained to detect fish.

In some implementations, the action includes adjusting a feeding system providing feed to the fish.

In some implementations, the action includes sending data including the predicted biomass value to a user device, where the data is configured to, when displayed on the user device, present a user of the user device with a visual representation of the predicted biomass value.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1A is a diagram showing an example of a system that is used for underwater camera biomass distribution forecasting.

FIG. 1B is a diagram showing an example of training a forecast model with historical biomass data.

FIG. 1C is a diagram showing an example of training a forecast model with historical truss network data.

FIG. 2 is a flow diagram showing an example process for underwater camera biomass distribution forecasting.

FIG. 3 is a diagram showing an example of a truss network.

FIG. 4 is a diagram illustrating an example of a computing system used for underwater camera biomass distribution forecasting.

Like reference numbers and designations in the various drawings indicate like elements.

### DETAILED DESCRIPTION

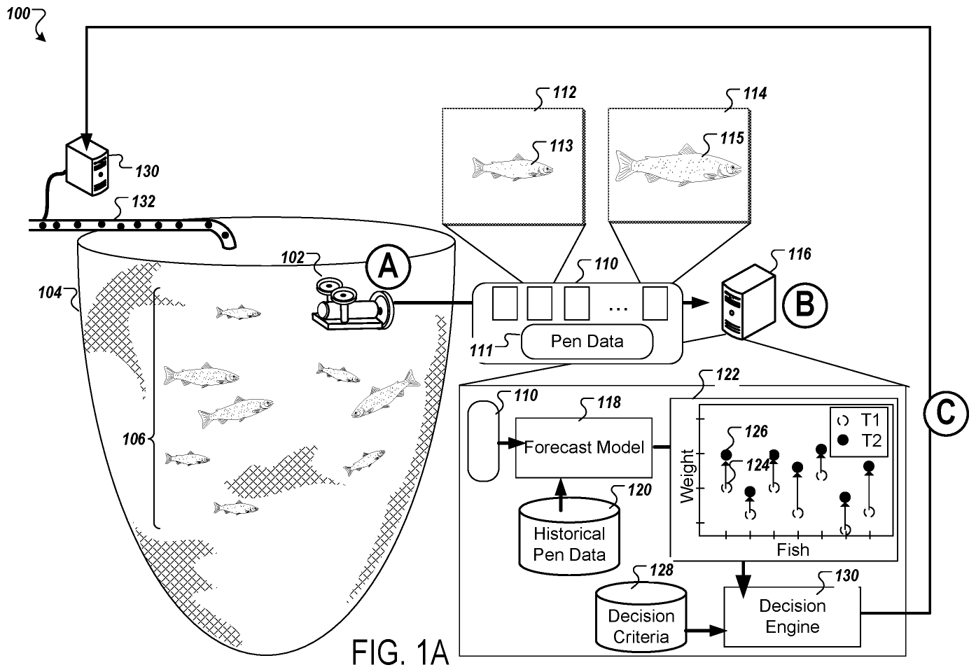

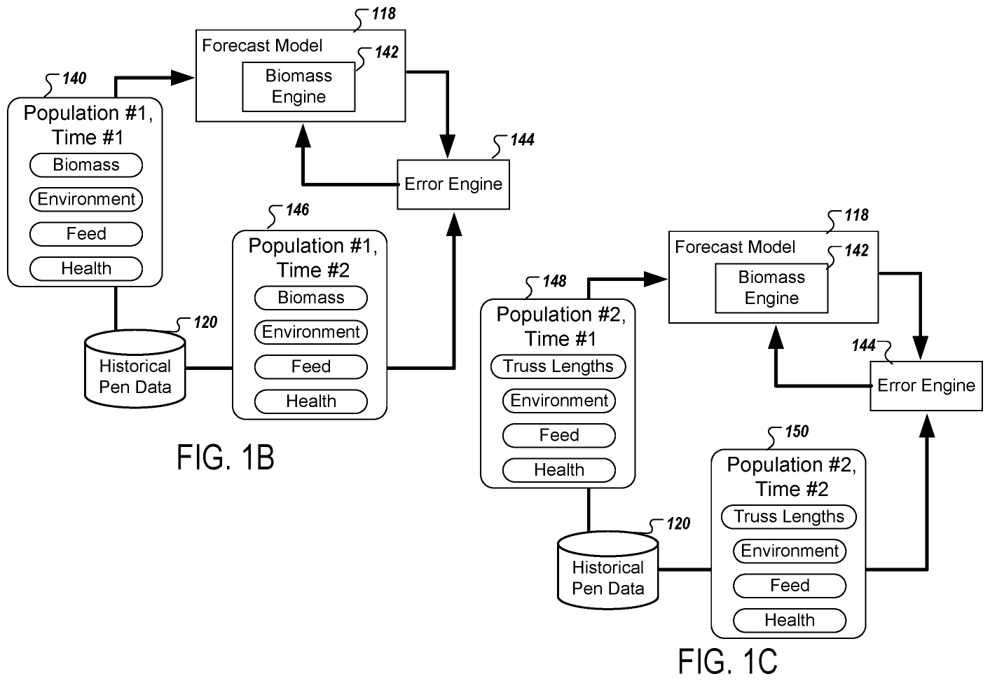

FIG. 1A is a diagram showing an example of a system 100 that is used for underwater camera biomass distribution forecasting. The system 100 includes a control unit 116 and an underwater camera device 102. Generally speaking, the control unit 116 obtains images captured by one or more cameras of the camera device 102 and processes the images to generate biomass predictions for the fish 106 in the fish pen 104. The biomass predictions for one or more fish can be processed to determine biomasses for one or more fish at a future point in time. In some implementations, the control unit 116 can perform one or more actions based on a generated projected biomass of the fish. For example, the control unit 116 can perform one or more of the following: feed adjustment, sorting, model training, and user report feedback, among others.

The system 100 also includes a feed controller unit 130 that controls the feed delivered by feed system 132. The feed controller unit 130 can include components configured to send control messages to actuators, blowers, conveyors, switches, or other components of the feed system 132. The control messages can be configured to stop, start, or change a meal provided to fish 106 in pen 104.

In this example, the camera device 102 includes propellers to move the camera device 102 around the fish pen 104. In general, the camera device 102 may use any method of movement including ropes and winches, waterjets, thrusters, tethers, buoyancy control apparatus, chains, among others.

In some implementations, the camera device 102 is equipped with the control unit 116 as an onboard component, while in other implementations, the control unit 116 is not affixed to the camera device 102 and is external to the camera device 102. For example, the camera device 102 may provide images 112 and 114 over a network to the control unit 116. Similarly, the control unit 116 can provide return data, including movement commands to the camera device 102 over the network.

Stages A through C of FIG. 1A, depict data 110, including image 112 and image 114, obtained by the camera device 102 that are processed by the control unit 116. In some implementations, the camera device 102 obtains pen data 111. The pen data 111 can include fish growth to date, water temperature information, water quality information, health information, actions performed, such as delousing events, fish feed information, among other data. In some implementations, one or more other sensors obtain the pen data 111. For example, stationary cameras, sensors on other components related to the fish pen 104, connected systems, among others, can obtain the pen data 111 and provide the pen data to the control unit 116.

The image 112 includes a representation of the fish 113. The image 114 includes a representation of the fish 115. Although images 112 and 114 show the fish 113 and 115 in a side profile view, images of fish obtained by the camera device 102 may include fish in any conceivable pose including head on, reverse head on, or skewed.

In stage A, the camera device 102 obtains the data 110 including images 112 and 114 of the fish 113 and 115 within the pen 104. The camera device 102 provides the data 110 to the control unit 116.

In stage B, the control unit 116 processes the data 110. The control unit 116 provides the data 110 to the forecast model 118. In some implementations, the forecast model 118 is trained using the historical pen data 120. For example, the historical pen data 120 can include information of one or more pens. The information of the one or more pens can include information about biomass changes to populations over time. The information can include conditions of the pens, such as water temperature information, water quality information, health information, actions performed, such as delousing events, fish feed information, among other data. The historical pen data 120 can include historic data from the fish pen 104 as well as other pens. In some implementations, the historical pen data 120 includes data of pens other than the fish pen 104.

In some implementations, the forecast model 118 includes one or more fully or partially connected layers. Each of the layers can include one or more parameter values affecting an output of the layers. The layers of the forecast model 118 can generate output indicating projected biomasses, or forecasted biomasses, of one or more fish, such as the fish 106, based on the data 110.

In some implementations, the forecast model 118 includes a biomass engine. FIG. 1B and FIG. 1C show an implementation of the forecast model 118 with biomass engine 142. The biomass engine 142 can obtain at least a portion of the data 110 and generate a biomass of one or more fish depicted by the data 110. In some implementations, the biomass engine 142 includes one or more models trained to predict a biomass of one or more fish based on images of one or more fish, such as the image 112 and the image 114. For example, the one or more models of the biomass engine 142 can be trained, by the control unit 116 or other entity, to generate biomass distribution predictions indicating how the biomass of a population of fish recorded in the historical pen data 120 is likely to change in the future. A training entity can compute an error term based on a predicted biomass or biomass distribution generated by the biomass engine 142 and a known biomass or biomass distribution for the fish specified in the historical pen data 120. The one or more models of the biomass engine 142 can use one or more training techniques, such as backpropagation, to update one or more weights based on a computed error term.

FIG. 1B is a diagram showing an example process for training the forecast model 118 using biomass data stored in the historical pen data 120. FIG. 1C is a diagram showing an example process for training the forecast model 118 using truss length data stored in the historical pen data 120. In FIG. 1B, the forecast model 118 obtains data 140 from the historical pen data 120. The data 140 includes information for a first population at a first time. The data 140 includes biomass data, environment data, feed data, health data, among others. In some implementations, the data 140 is used directly as input for one or more models of the forecast model 118. In some implementations, the forecast model 118 preprocesses one or more items of the data 140 before using the preprocessed items as input for the forecast model 118.

In FIG. 1B, the forecast model 118 generates a predicted biomass distribution based on the data 140. In general, one or more layers of the models of the forecast model 118 generate intermediate and final values based on the data 140 including the biomass data, environment data, feed data, and health data. An error engine 144 obtains the predicted biomass distribution generated by the forecast model 118. The error engine 144 obtains data 146 including information for the first population at a second time, e.g., subsequent to the first time corresponding to the data 140.

In some implementations, the error engine 144 is operated by the control unit 116. The error engine 144 compares the biomass of the data 146 corresponding to the biomass of the first population at the second time, with the predicted biomass distribution. In the example of FIG. 1B, the predicted biomass distribution generated by the forecast model 118 can include a biomass distribution corresponding to the second time. The predicted biomass distribution generated by the forecast model 118 can include predicted environment features, feed data, and health data.

The error engine 144 can generate a comparison result and provide the comparison result to the forecast model 118. In some implementations, the comparison result includes a vector indicating a difference between one or more parameters of the predicted biomass distribution, or other predictions, generated by the forecast model 118 and the biomass of the data 146 or other data of the data 146. As discussed herein, the forecast model 118, or a device operating the forecast model 118, such as the control unit 116, can adjust one or more parameters of one or more models of the forecast model 118 based on a comparison generated by the error engine 144. In some implementations, the forecast model 118 parameters are adjusted according to stochastic gradient descent algorithms or types of backpropagation.

In FIG. 1C, the forecast model 118 generates a predicted biomass distribution based on the data 148. The data 148 includes data corresponding to a second population at a first time. The data 148 includes truss length data. The biomass engine 142 can obtain the truss length data of the data 148 and generate, based on the truss length data, biomass data. The biomass data can be included, with one or more other items of data, such as the environment data, feed data, and health data of the data 148, as input for one or more models of the forecast model 118. The forecast model 118 generates a predicted biomass based on the data 148. In some implementations, the forecast model 118 can generate additional predictions. For example, the forecast model 118 can generate health predictions, environment predictions, feed predictions, among others.

As described in FIG. 1B, one or more layers of the models of the forecast model 118 can generate intermediate and final values based on the data 148 including the truss length data, environment data, feed data, and health data. An error engine 144 obtains the predicted biomass distribution generated by the forecast model 118. The error engine 144 obtains data 150 including information for the second population at a second time, e.g., subsequent to the first time corresponding to the data 148.

The error engine 144 can generate a comparison result based on comparing the data 150 with the generated data of the forecast model 118 and provide the comparison result to the forecast model 118. In some implementations, the comparison result includes a vector indicating a difference between one or more parameters of the predicted biomass distribution, or other predictions, generated by the forecast model 118 and the biomass of the data 150 or other data of the data 150.

In general, the data 140, 146, 148, and 150, can include data from fish of any fish pen. Fish pens can be separated geographically from one another. The historical pen data 120 can include location information corresponding to the data 140, 146, 148, and 150 indicating the location of the populations. In some implementations, environment data includes location information. In some implementations, the forecast model 118 is trained using data from particular locations. For example, the forecast model 118 can obtain data from Norway and regions that are similar in climate and environmental features to Norway.

In some implementations, the forecast model 118 is trained for specific locations. For example, a pen closer to the shore can have distinct features that affect growth or health of populations over time. Such effects can be determined using the historical pen data 120 for pens in particular geographic regions. Similarly, pens in deeper water or near a current can have distinct features that affect growth or health of populations over time. The forecast model 118 can be trained for specific locations based on stored data of the historical pen data 120 to determine the likely growth and health of a current population based on historical population growth.

In some implementations, the forecast model 118 does not include a biomass engine 142. For example, the biomass engine 142 can provide data to the forecast model 118. The control unit 116 can operate both the forecast model 118 and the biomass engine 142 or be communicably connected to a device that operates either or both of the forecast model 118 and the biomass engine 142.

In some implementations, the biomass engine 142 includes one or more models trained to predict a biomass or biomass distribution of one or more fish based on one or more truss networks. For example, as shown in FIG. 1A, a component of the forecast model 118 can generate a truss network for a particular fish depicted in an image of the data 110. The truss network can be generated based on a computed pose of the fish as well as a computed distance of various features on the fish from a camera. In some implementations, the forecast model 118 uses a depth perception model to determine three dimensional characteristics of the fish 113 and 115. In some implementations, the forecast model 118 obtains three dimensional data from the data 110. For example, three dimensional data can be obtained by a set of stereo cameras that can obtain the images 112 and 114.

In some implementations, the control unit 116 obtains ground truth data to train one or more models, such as one or more models of the biomass engine 142. For example, the control unit 116 can obtain ground truth data that includes one or more truss networks with corresponding known biomasses. The ground truth data can include a first truss network, with specific truss lengths, and a corresponding label indicating the known biomass of a fish from which the truss network was derived.

In training one or more models of the biomass engine 142, the control unit 116 can provide truss network data to the one or more models. The control unit 116 can obtain output of the one or more models indicating a predicted biomass based on the truss network data. The control unit 116 can compare the predicted biomass to the known biomass of the ground truth data and generate an error term. The control unit 116 can provide the error term to the one or more models or directly adjust one or more parameters of the one or more models based on the error term. In general, the one or more parameters can be adjusted to improve the accuracy of biomass predictions or reduce a difference value between the known biomass values of ground truth data and predicted values.

In some implementations, the biomass engine 142 of the forecast model 118 generates biomass predictions of one or more fish. For example, based on the data 110, the biomass engine 142 can generate a biomass estimation for one or more fish in the fish pen 104, including the fish 113 and the fish 115. The generated biomasses for the fish 113 and the fish 115 can include a biomass prediction of 5 kilograms for the fish 113 and 8 kilograms for the fish 115.

In some implementations, the forecast model obtains biomass data generated by a biomass engine 142 to determine a projected biomass for the fish 106 of the fish pen 104. For example, the forecast model 118 can use current biomass information together with other data, such as historical biomass data of the fish pen 104, conditions of the fish pen 104 (e.g., conditions of the water, feeding schedules, weather, among others), historical biomass data of other fish pens, conditions of the other fish pens, among others.

In some implementations, the control unit 116 can obtain historical pen data from pens that are similar to the fish pen 104. For example, the fish pen 104 can include fish of a particular type. The feed for the fish 106 can be a particular type of feed or can be provided on a particular feeding schedule. The fish pen 104 itself can be located at a particular geographical location. Factors such as these, among many others, can be obtained by the control unit 116. The historical pend data 120 can include data with one or more labels. The labels can indicate one or more factors used to distinguish between pens.

In some implementations, the control unit 116 compares one or more features of the fish pen 104 to one or more features of pens featured in the historical pen data 120. For example, the control unit 116 can generate one or more features of the fish pen 104, such as type of fish, location of the fish pen 104, feed provided, time of year, among others. The control unit 116 can query the historical pen data 120 for historical data that shares one or more of the features of the fish pen 104.

In some implementations, the control unit 116 obtains a threshold value indicating a threshold number of matching features and only provides historical data that satisfies the threshold number of matching features to the forecast model 118. In some implementations, the control unit 116 obtains a threshold type of features, such as type of fish, time of year, or any other feature, and only provides historical data that satisfies the threshold type of features to the forecast model 118.

In some implementations, the control unit 116 trains the forecast model 118. For example, the control unit 116 can provide ground truth data to the forecast model 118. In some implementations, the ground truth data includes historical pen data. For example, the control unit 116 can provide historical data to the forecast model 118. The historical data can include a known biomass distribution at points in time. The forecast model 118 can generate a projected biomass for a population of fish specified in the historical data. The control unit 116 can obtain the generated projected biomass and compare the generated projected biomass to a known biomass at the particular projected time for the population of fish. The control unit 116 can generate an error term and provide the error term to the forecast model 118.

In some implementations, the control unit 116 adjusts one or more values of the forecast model 118 based on a generated error term. In some implementations, the forecast model 118 uses one or more training techniques, such as backpropagation, to adjust one or more values of the forecast model 118. In general, the values of the forecast model 118 can be adjusted to reduce a difference between subsequent biomass predictions and known ground truth values for biomass at a corresponding time.

The forecast model 118 generates a forecast 122. In some implementations, the forecast 122 includes one or more predicted biomasses for each fish of the fish 106. In some implementations, the forecast 122 includes an average value of one or more groups of one or more fish of the fish 106. An implementation of the forecast 122 is shown graphically in FIG. 1. The forecast 122 of FIG. 1A shows biomass values of one or more fish at a first time (T1) and biomass values of one or more fish at a second time (T2).

The forecast 122 includes a biomass value 124 of one or more fish at T1 and a biomass value 126 of one or more fish at T2. In this example, T2 represents a future time proceeding T1. In some implementations, the biomass values 124 and 126 represent the biomass of a single fish. In some implementations, the biomass values 124 and 126 represent the biomass of a group of fish, such as a subpopulation of fish. For example, the control unit 116 can identify a subpopulation of fish. In some implementations, the forecast model 118 generates forecasts for particular subpopulations of fish identified by the control unit 116. In this way, the forecast model 118 can determine future growth of different populations, the growth of which can differ significantly across a range of different populations, such as runt, diseased, healthy, among others.

In some implementations, the forecast 122 includes only future biomass predictions. For example, instead of including a difference of the biomass 124 of a current time, or time preceding T2, and the biomass 126 of time T2, the forecast 122 can include just the projected biomass. In the example of FIG. 1A, the forecast model 118 can generate the forecast 122 to include the biomass 126 and other biomass values indicating biomass of fish corresponding to a future time.

In some implementations, the forecast model 118 generates a specific biomass for each fish. In some implementations, the forecast model 118 generates a biomass distribution for each fish. Instead of generating a distribution, the forecast model 118, including one or more trained models, can obtain the data 110, including image 112 and 114, and generate an indication of the most likely biomass at a particular time or multiple times based on the data. In some cases, truss length measurements can be generated and used as input data. In other cases, the forecast model 118 can simply generate biomass indications based on obtained images.

In some implementations, forecast model 118 generates a prediction for a single fish. For example, the fish can be identified based on characteristics of the fish depicted in an image, such as images 112 and 114. Characteristics of a fish, such as the fish 113 or 115, can be determined by one or more models trained to identify characteristics of fish. The one or more detected characteristics of a fish can be used to identify the fish. The characteristics can be adjusted overtime to account for growth or changes in a fish appearance. The fish can be identified by the control unit 116 in subsequent images by such an identification model.

In some implementations, the forecast model 118 is provided data corresponding to an identified fish. The forecast model 118 can process information corresponding to the identified fish to determine a projected growth for the identified fish. As discussed herein, the forecast model 118 can obtain, or be provided by the control unit 116, the historical pen data 120. The historical pen data 120 can include data on one or more specific fish and corresponding environmental information. By comparing the features of the historical data to the features of the current identified fish, the forecast model 118 can predict a projected growth for the identified fish.

In some implementations, the forecast model 118 is trained for generating biomass growth forecasting for distributions of fish. The forecast model 118 can be trained by providing sample data from a distribution of fish, predicting a projected biomass of that distribution, and comparing the predicted future biomass to a known future biomass of the distribution of fish included in the historical pen data 120.

In some implementations, the forecast model 118 predicts future biomass based on the growth of an identified fish or the growth of a distribution of fish to date, environmental information of the pen 104, health information of one or more of the fish 106, and feeding information of the fish 106.

In some implementations, the forecast model 118 generates one or more values representing the fish pen 104 over time. For example, the forecast model 118 can generate growth metrics, such as Feed Conversion Ratio (FCR) and Relative Growth Index (RGI). The forecast model 118 can generate growth metrics at multiple points in time. For example, the forecast model 118 can generate growth metrics at a current time. The forecast model 118 can generate growth metrics at T2, representing some future point in time.

In some implementations, the forecast model 118 generates one or more values indicating an impact of various environmental effects. For example, the forecast model 118 can generate a forecast 122 that includes an effect on the environment, such as algae blooms, pollution, oxygen levels, or other environmental features. Using known correlations or data of the historical pen data 120, the forecast model 118 can generate one or more values indicating the effect of such environmental effects on a projected biomass of the fish 106.

In some implementations, the forecast model 118 generates one or more values indicating an impact of various health effects. For example, the forecast model 118 can generate a forecast 122 that includes an effect of a parasite affecting the fish 106, such as sea lice, Ichthyophthirius multifiliis, among others. The forecast 122 can indicate deaths, or loss of population. Such loss in population can be due to disease, parasites, or age.

The forecast model 118 provides the forecast 122 to the decision engine 130. In some implementations, the control unit 116 obtains the forecast 122 and provides the forecast 122 to the decision engine 130. The decision engine 130 obtains the forecast 122. The decisions engine 130 computes a decision based on the forecast 122.

In some implementations, the decision engine 130 determines one or more actions to perform. For example, the decision engine 130 can determine when to harvest one or more of the fish 106, whether to do a partial harvest of certain populations of fish (e.g. fish currently satisfying a weight threshold or fish that are projected to satisfy a weight threshold), whether to sort the fish based on fish size or projected fish size, whether to treat all or some of the fish, whether to change the feeding strategy for all or some of the fish.

In some implementations, the control unit 116 obtains decision criteria 128. The control unit 116 can obtain the decision criteria 128 from a server, connected component, or as input from a user. The decision criteria 128 can include one or more actions available to the control unit 116. For example, if a sorting actuator is functional and communicably connected to the control unit 116, the decision criteria 128 can include an indication that sorting is an available decision. The decision criteria 128 can include further availability information, such as an indication of functional status, availability, or other information of connected systems, such as the feed system 132.

In some implementations, the decision model 130 generates a feeding strategy and feed amount. For example, the decision model 130 can determine one or more parameters of a feeding strategy including a minimum feeding rate, a maximum feeding rate, or a maximum feeding amount. A feeding strategy can include when to feed fish. A feeding strategy can include what type of feed to provide to fish.

In some implementations, the decision engine 130 determines whether to change the feeding strategy for all or some of the fish. For example, the decision model 130 can obtain a threshold and compare the threshold with data from the forecast 122. The threshold can be a biomass threshold. If the threshold is a biomass threshold, the decision model 130 can determine, based on comparing biomasses of one or more fish to the threshold, whether to change the feeding strategy for those one or more fish. For example, if the biomasses of one or more fish of the fish 106 satisfy the threshold, the decision model 130 can generate and provide a control signal to the feeding system 130 to adjust a feeding strategy for the one or more fish.

In some implementations, adjusting a feeding strategy for one or more fish of the fish 106 includes sorting the one or more fish. For example, in order for the feeding adjustments to only affect the one or more fish, the decision model 130 can generate and provide a control signal to a sorting system configured to sort the one or more fish into a portion of the fish pen 104 or a different pen.

In some implementations, the decision engine 130 determines when to harvest the fish and whether to do a partial harvest of certain populations of fish. For example, the decision engine 130 can determine based on current biomass values or a forecast, such as forecast 122, that the fish 106 satisfy one or more thresholds for harvesting. The decision engine 130 can then generate and provide a control signal to a harvesting system to harvest the fish 106. The decision engine 130 can generate and provide a control signal to a harvesting system to harvest only a portion of the fish 106. For example, the decision engine 130 can determine a subpopulation that has not grown to a harvesting biomass. The decision engine 130 can generate a signal indicating to a harvesting system that a subpopulation should be harvested while another subpopulation, such as a subpopulation that has not grown to a harvesting biomass, should not be harvested.

In some implementations, the decision engine 130 determines whether to sort the fish based on fish size. For example, the decision engine 130 can obtain a threshold, e.g., a biomass threshold. The decision engine 130 can compare the threshold to data of the forecast 122. Based on comparing the threshold to data of the forecast, the decision engine 130 can determine to sort one or more fish that satisfy the threshold from one or more fish that do not satisfy the threshold.

In some implementations, the decision engine 130 determines whether to treat all or some of the fish. For example, based on the forecast 122, the decision engine 130 can determine whether to treat a portion of the fish 106. In some implementations, the decision engine 130 compares health data of the fish 106 to a health threshold, such as a health threshold indicating a healthy fish or not healthy fish. For example, the decision engine 130 can compare health data of the fish 106 to the health threshold and based on a portion of the fish 106 satisfying the threshold, determine whether to treat the portion. The decision engine 130 can generate and provide a control signal to a treatment system configured to treat one or more of the fish 106.

In stage C, the control unit 116 determines an action based on the forecast 122. In the example of FIG. 1A, the decision engine 130 generates a decision to adjust feeding for the fish pen 104 using an indication of the feed system 132 being available in the decision criteria 128.

In some implementations, the forecast 122 includes one or more biomass distributions. For example, the forecast model 118 can provide biomass estimation for multiple fish. The decision engine 130 can detect one or more features of the biomass estimations. For example, the decision engine 130 can detect one or more subpopulations. Subpopulations can include runt fish, healthy fish, diseased fish, among others. The subpopulations can exist at a particular time in the future or can exist at a current time. The forecast 122 can include fish data corresponding to multiple times including a current time and one or more times in the future.

In some implementations, the decision engine 130 detects a runt subpopulation based on processing the forecast 122. For example, the decision engine 130 can include one or more algorithms or trained models to detect groups within a distribution of data. The decision engine 130 can include one or more processors configured to perform clustering algorithms such as k-mean, partitioning methods, hierarchical clustering, fuzzy clustering, density-based clustering, model-based clustering, among others.

In some implementations, the control unit 116 determines an adjustment of feed using the feed controller unit 130 controlling the feed system 132. The control unit 116 can provide the data, including the forecast 122, or a control signal to the feed controller unit 130. Depending on the data received from the control unit 116, the feed controller unit 130 can either process the data to determine an adjustment of feed and provide a control signal to the feed system 132 or can provide the control signal provided by the control unit 116 to the feed system 132.

In some implementations, the decision engine 130 does not detect a runt subpopulation. For example, the decision engine 130 can detect a biomass distribution from the forecast 122 that does or does not satisfy a biomass requirement or threshold, such as a biomass requirement for distribution or sale. The decision engine 130 can determine, based on features of the biomass distribution, what action to perform.

For example, if one or more biomass predictions generated by the forecast model 118 do not satisfy a threshold (e.g., the mean or median biomass is too large or too small), the control unit 116 can provide a control signal to a sorting actuator of a sorting system to sort one or more fish from the fish 106 or can provide a control signal to adjust a feeding of the fish 106. For example, the control unit 116 can sort the fish 106 based on biomass. The control unit 116 can send a signal to a sorting system that sorts fish based on one or more criteria, such as a threshold biomass, into multiple locations based on the one or more criteria.

In some implementations, the forecast model 118 generates one or more values indicating an effect of an action. For example, an effect of a treatment could be a projected health of a fish increasing in the future or the biomass of the fish increasing at some future time. In general, present actions, or planned actions, can be included in input to the forecast model 118. The forecast model 118 can determine, based on the planned or present actions, effects for a corresponding population. In some implementations, the forecast model 118 obtains data from the historical pen data 120 that includes actions taken on a population. Based on the future growth or general change of the population after the action was taken, the forecast model 118 can be trained to determine similar effects for a current population.

In some implementations, the control unit 116 provides the forecast 122 to a user. In some implementations, the forecast 122 is provided with one or more features indicating possible causes for changes in projected biomass overtime. In general, the forecast 122 can be provided with insight to the processing of the control unit 116, such as the processing of the forecast model 118 in determining a particular forecast. For example, provided forecasts, such as forecast 122, can be paired with explanations to provide insight into the forecast model 118.

In some implementations, the control unit 116 provides additional data to a user with the forecast 122. For example, additional data can include an explanation at one or more inflection points along a graphical representation of the forecast 122 that shows changes over time, such as changes to biomass of one or more fish. For a forecasted growth of a distribution of fish, the control unit 116 can generate one or more explanations based on the forecast 122.

In some implementations, the forecast 122 includes explanations based on one or more features used to generate values of a population at a particular time. For example, the forecast model 118 can use one or more features of the current data 110 and the historical pen data 120 to determine one or more values indicating forecasted values. In the case of forecasted biomass, the forecast model 118 can determine one or more biomasses of the fish 106 at T2 increases from a previous time by a first amount. To generate the projected biomass, the forecast model 118 can weight or otherwise select certain elements of the current data 110 and the historical pen data 120.

In some implementations, certain elements that satisfy a weighting threshold are provided in an explanation to a user for a particular feature of the forecast 122. For example, one or more sets of previous fish populations detailed in the historic pen data 120 may have grown according to a particular growth pattern. If these populations include features similar to the fish pen 104, the control unit 116 can obtain the data of these fish populations and use the data to determine a projected growth of the fish pen 104. Although the forecast model 118 can rely on other data, such as data used in training, the forecast 122 can include similar data from the historical pen data 120 to describe the forecast 122. For example, the control unit 116 can generate an explanation that includes data from the historical pen data 120 and an indication of similarities between the historical pen data 120 and the fish pen 104.

In some implementations, the forecast 122 includes a portion of time where the forecasted growth proceeds less rapidly or growth decreases. The control unit 116, at these points, or along other points of a graphical representation of the forecast 122, can include an explanation. In some implementations, explanations can include health actions forecasted to occur. For example, an explanation can indicate that a scheduled delousing event occurs. Such an event can decrease a growth rate for the fish 106 for a period of time.

In some implementations, the forecast 122 includes a runt population growing over time. The control unit 116, at this point, or along other points of a graphical representation of the forecast 122, can generate and include an explanation provided to a user with data of the forecast 122. In some implementations, explanations can include historical data. For example, an explanation can indicate similar runt populations from the historical pen data 120 that developed in a similar way under similar conditions.

In some implementations, the forecast 122 includes multiple projections. For example, the forecast 122 can include data of a first projection that assumes weather conducive for growth or other factors, optimal feeding, among others. The forecast 122 can include data of a second projection that assumes at least a portion of weather not conducive for growth or another factor, less than optimal feeding, among others. The control unit 116 can generate explanations for the multiple projections. For example, explanations for projections can include what assumptions are made by the forecast model 118. In the example discussed, an explanation of the first projection can include an indication of the type of weather assumed, feeding conditions, among others.

In some implementations, the forecast 122 includes at least one projection indicated as a most likely projection. For example, the forecast model 118 can obtain data from a particular facility, a particular pen, a particular feeding strategy historically used on the fish 106. The forecast model 118 can extrapolate at least a portion of the data to determine a projection of future development of the fish 106. The forecast model 118 can also generate projections where one or more factors, such as weather, environmental conditions, feeding, disease, are more or less optimal. For example, the forecast model 118 can generate a forecast 122 that includes a projected growth of the fish 106 if provided with optimal feeding, less optimal feeding, and poor feeding, among others. The forecast model 118 can generate a projected yield of the population based on the feeding to calculate a profit margin obtained based on feed saved or lost compared to a corresponding increase in population that satisfies a criteria for sale, e.g., healthy, no disease, no deformations.

The control unit 116 can generate a signal including the forecast 122 to a user device. The signal can be configured to display the forecast 122 in a graphical user interface of the user device. The graphical user interface can be configured to adapt to input from a user. For example, input by a user can show or hide additional information based on the forecast 122.

In some implementations, the control unit 116 includes the feed controller unit 130. For example, the control unit 116 may control both the processing of the images in the data 110 and the adjustments to the feeding by controlling the feed system 132.

In some implementations, the control unit 116 adjusts feeding to provide feed to a certain area of the fish pen 104. For example, the obtained data 110 can include positions of the fish detected within the images of the obtained data 110. The control unit 116 can determine based on one or more subpopulations detected by the decision engine 128 of the control unit 116 that a given subpopulation requires additional feed.

The control unit 116 can send a control signal to the feed system 132 or to the control unit 130 for the feed system 132 configured to adjust the location of an output of feed. The control unit 116 can adjust the location of an output of feed to a location of one or more fish within a particular subpopulation or an average location of the subpopulation.

In some implementations, the feed system 132 includes the ability to provide multiple food types. For example, the controller unit 130 can provide control messages to the feed system 132 to change the food type provided to the fish 106. In some cases, the multiple food types include a medicated food type and a non-medicated food type. In some cases, the multiple food types include food with a particular nutritional value and food with a different nutritional value.

The controller unit 130 can determine, based on data from the control unit 116, which food to provide to the fish 106, how much food to provide, when to provide the food, and at what rate to provide the food. In general, the controller unit 130 can generate a meal plan based on data from the control unit 116, such as biomass predictions, forecasts (e.g., forecast 122), or a control signal generated based on biomass predictions, where the meal plan includes one or more of: a feed type, a feed rate, a feed time, and a feed amount.

In some implementations, the control unit 116 includes multiple computer processors. For example, the control unit 116 can include a first and a second computer processor communicably connected to one another. The first and the second computer processor can be connected by a wired or wireless connection. The first computer processor can perform one or more of the operations of the forecast model 118 or the decision engine 130. The first computer processor can store or provide the historical pen data 120 or the decision criteria 128.

Similarly, the second computer processor can perform one or more of the operations of the forecast model 118 or the decision engine 130. The second computer processor can store or provide the historical pen data 120 or the decision criteria 128. Operations not performed by the first computer processor can be performed by the second computer processor or an additional computer processor. Operations not performed by the second computer processor can be performed by the first computer processor or an additional computer processor.

In some implementations, the control unit 116 operates one or more processing components, such as the forecast model 118 or the decision engine 130. In some implementations, the control unit 116 communicates with an external processor that operates one or more of the processing components. The control unit 116 can store the historical pen data 120 or the decision criteria 128, or other data used to train one or more models of the processing components, or can communicate with an external storage device that stores data including the historical pen data 120 or the decision criteria 128.

In some implementations, the forecast model 118 generates, for each fish and across multiple weight ranges, the likelihood that the fish's weight is within a given weight range at any particular time or multiple times. The collection of likelihoods for each weight range corresponding to a fish can be represented as a distribution. For example, weight ranges for a given biomass distribution may include ranges from 3 to 3.1 kilograms (kg), 3.1 to 3.2 kg, and 3.2 to 3.3 kg. A likelihood that the actual biomass of the fish 113 is within the first range, 3 to 3.1 kg, can be 10 percent. A likelihood that the biomass of the fish 113 is within the second or third range, 3.1 to 3.2 kg or 3.2 to 3.3 kg, respectively, can be 15 percent and 13 percent. In general, the sum of all likelihoods across all weight ranges can be normalized (e.g., equal to a value, such as 1, or percent such as 100 percent).

In some implementations, the weight ranges are indicated as values on an x axis of a distribution representation. For example, a Gaussian, or Gaussian-like form can indicate a likelihood, shown on the y axis, for each weight range across a range of weight ranges, shown on the x axis.

In some implementations, the decision engine 130 determines one or more actions to perform. For example, the decision engine 130 can determine whether there is a growing population of runt or low performing fish. The decision engine 130 can determine whether there is a growing population of foreign fish. For example, the forecast 122 can include one or more values indicating a number of foreign fish within the fish pen 104 at one or more times. Foreign fish can include fish that have moved from an environment outside of the fish pen 104 into the fish pen 104 or fish that are not of the type raised in the fish pen 104.

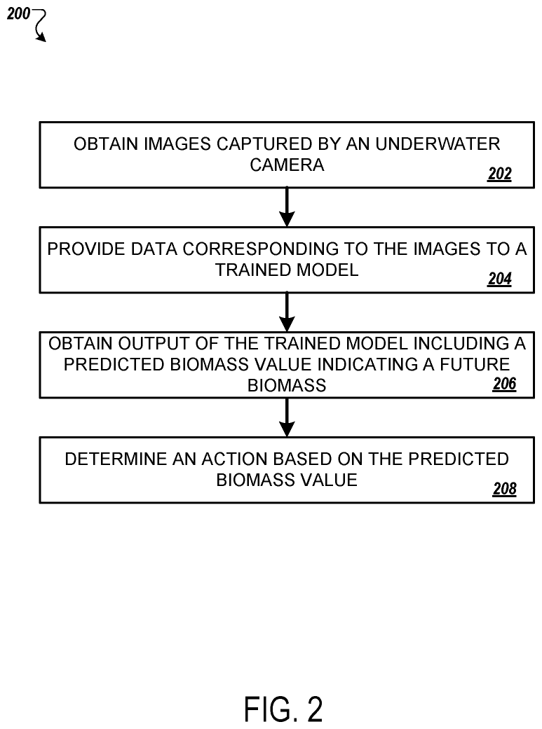

FIG. 2 is a flow diagram showing an example of a process 200 for underwater camera biomass estimation. The process 200 may be performed by one or more systems, for example, the system 100 of FIG. 1.

The process 200 includes obtaining images captured by an underwater camera (202). For example, the control unit 116 can obtain the data 110, including images 112 and 114 from the camera device 102.

The process 200 includes providing data corresponding to the images to a trained model (204). For example, the control unit 116 can provide the data 110 to the forecast model 118. The control unit 116 can provide the pen data 111 to the forecast model 118 including data such as growth of the fish 106 to date, water temperature of water in or around the fish pen 104, water quality of water in or around the fish pen 104, health information (e.g., delousing events) and feeding information.

The process 200 includes obtaining output of the trained model including a predicted biomass value indicating a future biomass (206). For example, the control unit 116 can obtain the forecast 122. The forecast 122 can include one or more predicted biomass values for one or more fish of the fish 106. In some implementations, the forecast 122 includes a biomass distribution. For example, the forecast 122 can indicate a number of fish corresponding to one or more ranges of biomass. The forecast 122 can include values similar to a histogram indicating a number of fish corresponding to one or more ranges of biomass.

The process 200 includes determining an action based on the predicted biomass value (208). For example, the decision engine 130 can obtain the forecast 122 and determine an action corresponding to adjusting the feed of the fish 106. The action can be included in the decision criteria 128.

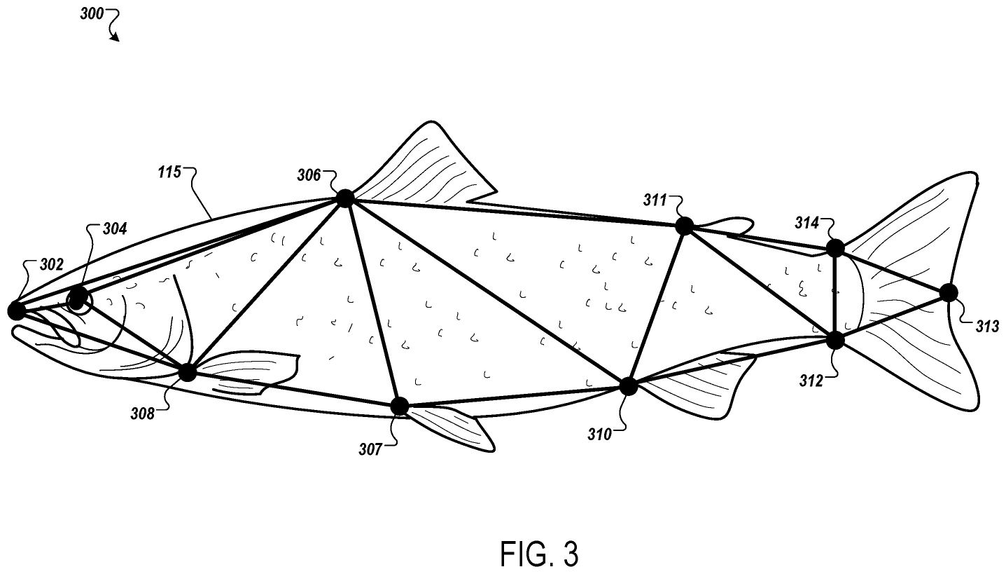

FIG. 3 is a diagram showing an example of a truss network 300. FIG. 3 shows truss lengths and key points. As discussed herein, the control unit 116 can compute truss lengths for one or more fish, such as the fish 113 and the fish 115, in order to generate a predicted biomass. FIG. 3 shows such a truss network for the fish 115.

The truss lengths between key points are used to extract information about the fish including a weight of the fish. Various trusses, or lengths between key points, of the fish can be used. FIG. 3 shows a number of possible truss lengths including upper lip 302 to eye 304, upper lip 302 to leading edge dorsal fin 306, upper lip 302 to leading edge pectoral fin 308, leading edge dorsal fin 306 to leading edge anal fin 310, leading edge anal fin 310 to trailing low caudal peduncle 312, trailing lower caudal peduncle 312 to trailing upper caudal peduncle 314. Other key points and other separations, including permutations of key points mentioned, can be used. For different fish, or different species of fish, different key points may be generated. For any set of key points, a truss network may be generated as a model.

Other truss lengths not shown can be used by the system 100. For example, a truss length from the upper lip 302 to the tail 313 can be used as the length of the fish 115 and included in a collection of one or more truss length measurements and provided in the forecast model 118 to generate a biomass distribution. In addition, specific truss lengths can be used to recognize specific deformities. Deformities such as shortened operculum can be detected using truss lengths such as a truss length from the upper lip 302 to the gill. Processing one or more images of a fish can include determining any of the following health conditions: shortened abdomen, shortened tail, scoliosis, lordosis, kyphosis, deformed upper jaw, deformed lower jaw, shortened operculum, runting or cardiomyopathy syndrome (CMS).

In some implementations, the forecast 122 includes health data related to one or more fish represented. For example, the forecast 122 can include health probabilities as well as, or instead of, biomass distributions. The health probabilities can be used to determine various remedial actions to be taken at a present time or in the future. Such remedial actions can include providing medicated feed or moving the fish to a system for treatment, such as delousing. The forecast 122 can also show the occurrences of health related issues within a population, such as the fish 106, or for a particular fish over time.

Although the examples herein discuss fish, other animals, including livestock can be equally applicable to the described techniques. For example, a camera device on an agricultural property can capture images of cows and provide the images to the control unit 116 for processing. The control unit 116 can provide a forecast based on the images and historical data of agricultural projects to a user as well as perform one or more automated actions, such as feeding adjustments, sorting, or the like, as discussed herein with respect to aquaculture and fish in particular.

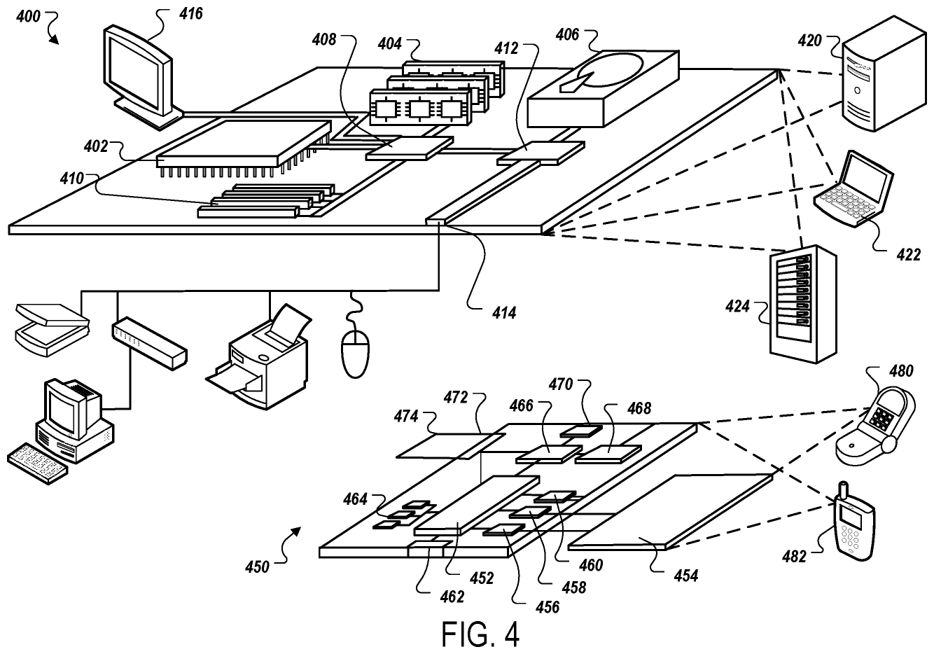

FIG. 4 is a diagram illustrating an example of a computing system used for biomass prediction aggregation. The computing system includes computing device 400 and a mobile computing device 450 that can be used to implement the techniques described herein. For example, one or more components of the system 100 could be an example of the computing device 400 or the mobile computing device 450, such as a computer system implementing the control unit 116, devices that access information from the control unit 116, or a server that accesses or stores information regarding the operations performed by the control unit 116.

The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only and are not meant to be limiting.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as a display 416 coupled to the high-speed interface 408. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor 402 is a single threaded processor. In some implementations, the processor 402 is a multi-threaded processor. In some implementations, the processor 402 is a quantum computer.

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 402), perform one or more methods, such as those described above. The instructions can also be stored by one or more storage devices such as computer- or machine readable mediums (for example, the memory 404, the storage device 406, or memory on the processor 402). The high-speed interface 408 manages bandwidth-intensive operations for the computing device 400, while the low-speed interface 412 manages lower bandwidth-intensive operations. Such allocation of functions is an example only. In some implementations, the high speed interface 408 is coupled to the memory 404, the display 416 (e.g., through a graphics processor or accelerator), and to the high-speed expansion ports 410, which may accept various expansion cards (not shown). In the implementation, the low-speed interface 412 is coupled to the storage device 406 and the low-speed expansion port 414. The low-speed expansion port 414, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device, such as a mobile computing device 450. Each of such devices may include one or more of the computing device 400 and the mobile computing device 450, and an entire system may be made up of multiple computing devices communicating with each other.

The mobile computing device 450 includes a processor 452, a memory 464, an input/output device such as a display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may include appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a SIMM (Single In Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provided as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or NVRAM memory (nonvolatile random access memory), as discussed below. In some implementations, instructions are stored in an information carrier such that the instructions, when executed by one or more processing devices (for example, processor 452), perform one or more methods, such as those described above. The instructions can also be stored by one or more storage devices, such as one or more computer- or machine-readable mediums (for example, the memory 464, the expansion memory 474, or memory on the processor 452). In some implementations, the instructions can be received in a propagated signal, for example, over the transceiver 468 or the external interface 462.

The mobile computing device 450 may communicate wirelessly through the communication interface 466, which may include digital signal processing circuitry in some cases. The communication interface 466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 4G/6G cellular, among others. Such communication may occur, for example, through the transceiver 468 using a radio frequency. In addition, short-range communication may occur, such as using a Bluetooth, Wi-Fi, or other such transceiver (not shown). In addition, a GPS (Global Positioning System) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, among others) and may also include sound generated by applications operating on the mobile computing device 450.

The mobile computing device 450 may be implemented in a number of different forms, as shown in the figure. For example, it may be implemented as a cellular telephone 480. It may also be implemented as part of a smart-phone 482, personal digital assistant, or other similar mobile device.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the invention have been described. Other embodiments are within the scope of the following claims. For example, the steps recited in the claims can be performed in a different order and still achieve desirable results.

What is claimed is:

1. A method comprising:
obtaining one or more images of a population of fish captured by an underwater camera;
providing data corresponding to the one or more images to a model trained to predict biomass values;
obtaining output of the trained model including a predicted biomass value indicating a future biomass of a fish within the population of fish; and
determining an action based on the predicted biomass value.

2. The method of claim 1, wherein the data corresponding to the one or more images comprises:
historical data of the fish, including one or more values indicating historical biomasses of the fish.

3. The method of claim 1, comprising training the model, wherein training the model includes:
providing a portion of historical data of one or more fish not included in the population of fish to the model;
obtaining output of the model indicating predicted biomass values of the one or more fish;
generating an error term by comparing the predicted biomass values to known biomass values of the one or more fish included in a second portion of the historical data; and
adjusting one or more parameters of the model based on the error term.

4. The method of claim 3, wherein adjusting the one or more parameters of the model based on the error term comprises:
providing the error term to the model configured to perform backpropagation.

5. The method of claim 1, comprising:
determining, based on the one or more images, a data set including a value that indicates a length between a first point on the fish and a second point on the fish.

6. The method of claim 5, comprising:
providing the data set including the value that indicates the length between the first point on the fish and the second point on the fish to a model trained to predict biomass; and
obtaining output of the model trained to predict biomass as a biomass value of the fish.

7. The method of claim 6, wherein the data corresponding to the one or more images comprises:
the biomass value of the fish.

8. The method of claim 5, comprising:
detecting the first point and second point on the fish.

9. The method of claim 8, wherein detecting the points comprises:
providing the images to a model trained to detect feature points on a fish body.

10. The method of claim 1, comprising:
detecting the fish within an image of the one or more images using a model trained to detect fish.

11. The method of claim 1, wherein the action comprises:
adjusting a feeding system providing feed to the fish.

12. The method of claim 1, wherein the action comprises:
sending data including the predicted biomass value to a user device, wherein the data is configured to, when displayed on the user device, present a user of the user device with a visual representation of the predicted biomass value.

13. A non-transitory, computer-readable medium storing one or more instructions executable by a computer system to perform operations comprising:
obtaining one or more images of a population of fish captured by an underwater camera;
providing data corresponding to the one or more images to a model trained to predict biomass values;
obtaining output of the trained model including a predicted biomass value indicating a future biomass of a fish within the population of fish; and
determining an action based on the predicted biomass value.

14. The medium of claim 13, wherein the data corresponding to the one or more images comprises:
historical data of the fish, including one or more values indicating historical biomasses of the fish.

15. The medium of claim 13, wherein the operations comprise training the model, wherein training the model includes:
providing a portion of historical data of one or more fish not included in the population of fish to the model;
obtaining output of the model indicating predicted biomass values of the one or more fish;
generating an error term by comparing the predicted biomass values to known biomass values of the one or more fish included in a second portion of the historical data; and
adjusting one or more parameters of the model based on the error term.

16.-19. (canceled)

20. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
obtaining one or more images of a population of fish captured by an underwater camera;
providing data corresponding to the one or more images to a model trained to predict biomass values;
obtaining output of the trained model including a predicted biomass value indicating a future biomass of a fish within the population of fish; and
determining an action based on the predicted biomass value.

21. The method of claim 1, wherein the predicted biomass value includes a distribution of biomasses for a group of fish that includes the fish.

22. The method of claim 21, wherein the distribution of biomasses for the group of fish includes a probability distribution.

23. The method of claim 1, wherein the action comprises:
adjusting one or more of a fish health forecast or a sales price forecast.

24. The method of claim 1, wherein the predicted biomass value includes an uncertainty estimate.
